(19) United States
(12) Patent Application Publication
(10) Pub. No.: US 2024/0118026 A1
(43) Pub. Date: Apr. 11, 2024

(54) Freeze Drying Aromatic Plant Matter

(71) Applicant: The Original Resinator, LLC, Graton, CA (US)

(72) Inventor: Travis Jeremy Arnovick, Graton, CA (US)

(73) Assignee: The Original Resinator LLC, Graton, CA (US)

(21) Appl. No.: 18/252,530

(22) PCT Filed: Nov. 11, 2021
(86) PCT No.: PCT/US21/72363

§ 371 Date: May 10, 2023

Related U.S. Application Data
(63) Continuation-in-part of application No. PCT/US21/72363, filed on Nov. 11, 2021.
(60) Provisional application No. 63/112,346, filed on Nov. 11, 2020.

(51) Int. Cl. F26B 5/06; F26B 1/00; F26B 21/08; F26B 21/10

(52) U.S. Cl. CPC F26B 5/06; F26B 1/00; F26B 21/08; F26B 21/10

(57) ABSTRACT

A process of freeze-drying plant matter may deploy inert freezing agent to fracture undesirable plant matter into smaller fragments for physical separation from plant buds and flowers, which are rich in aromatic trichomes. The frozen buds and flowers or trichomes are removed from the sieving members used for physical separation and maintained in a frozen state until introduced in a pre-chilled vacuum chamber of a freeze-drying system. The freeze-drying apparatus is configured and deployed in a process that maintains the pressure above about 500 mTorr but below about 1500 mTorr to reduce the plant moisture content to provide a stable product.

### CROSS REFERENCE TO RELATED APPLICATIONS

The present application is a Continuation-in-part of claims the benefit of priority to the International (PCT) patent application with the application no. PCT/US21/72363 that was filed on Nov. 11, 2021, and is incorporated herein by reference, which in turn claims the benefit of priority to the US provisional patent application of the same title that was filed on Nov. 13, 2020, having application Ser. No. 61/113,346 and is also incorporated herein by reference.

### BACKGROUND

The field of innovation is the processing of plant matter containing aromatic, flavoring and/or medicinal compounds such as linear, mono and cyclic terpenes and cannabinoids and more particularly using freezing processes and freeze drying to separate undesired material to better extract and preserve the state of desired chemical compounds and constituents.

Cannabis plants such as hemp, with less than 0.3% THC (tetrahydrocannabinol) by dry weight, are particularly rich in the cannabinoid compound CBD (cannabidiol) which has known therapeutic properties for the treatment of medical conditions. Hemp and other Cannabis plants may also contain other cannabinoids such as THC-A (tetrahydrocannabinolic acid)), CBN (cannabinol), CBG (cannabigerol), CBC (cannabichromene), CBDA (cannabidiolic acid), CBL (cannabicyclol), CBV (cannabivarin), THCV (tetrahydrocannabivarin), THCP (tetrahydrocannabiphorol), CBDV (cannabidivarin), CBCV (cannabichromevarin), CBGV (cannabigerovarin), CBGM (cannabigerol monomethyl ether), CBE (cannabielsoin) and CBT (cannabicitran). Hemp and other Cannabis plants also contain varying amounts of linear and cyclic terpene and terpinoids that are based on number of isoprene units, such as myrcene, limonene, linalool, a-pinene, b-caryophyllene, terpinolene, eucalyptol, humulene, nerolidol, ocimene, a-bisabolol and the like. The medicinal and recreational benefits derived from Cannabis consumption varies with different strains and is believed to be the result of the synergy between the various cannabinoids and the terpenes, which vary among strains.

Cannabis plants are traditionally dried after harvest. During the 14-30 days it takes the cannabis plant to dry, the enzymes that cause plant senescence deteriorate as they act on the chlorophyll The drying is preferably at least these 14-30 days to the chlorophyll is eliminated to remove the “green” or grassy taste when the product is consumed by smoking.

During such drying the THC-A undergoes decarboxylation, converting it into the psychoactive compounds Δ9 THC, & CBN. It is believed these, and possibly other cannabinoids, are responsible for making users feel drowsy or lethargic. Linear terpene compounds are also lost in conventional drying.

Plants undergoing conventional drying are also subject to spoilage and deterioration and require large secure spaces to avoid theft, and also adds to overhead costs of operations.

It would be desirable to provide a method to process aromatic plants like hops, hemp, cannabis that is faster than air drying and rapidly removes undesirable components, yet preserves desirable components and compounds, particularly both the cannabinoids and the terpenes.

The above and other objects, effects, features, and advantages of the present innovations will become more apparent from the following description of the embodiments thereof taken in conjunction with the accompanying drawings.

### SUMMARY

In the present innovations, a first object is achieved by providing a process for freeze drying of plant matter that comprises the steps of freezing the plant matter with a liquid freezing agent at atmospheric pressure to one of fragments undesired plant matter and to dislodge desired plant matter such that desired plant matter remains on a sieving member, with the fragmented plant matter passing through the sieving member, removing the desired plant matter from the sieving member while frozen, providing one of a storage and a vacuum chamber that is prechilled to at or 32° F. (0° C.) below to receive the desired frozen plant matter from the sieving member, introducing the desired frozen plant matter to the pre-chilled vacuum chamber, reducing the pressure in the vacuum chamber for a pre-determined amount of time to sublime frozen water in the plant matter under a pressure not lower than 500 mTorr and below at least 1500 mTorr, maintaining the plant matter at temperature below about 32° F. (0° C.) until the pressure in the vacuum chamber is reduced to below at least about below at least 1500 mTorr, raising the temperature of the plant matter in the vacuum chamber to not more than 55° F. (12.3° C.) in one or more stages to convert the plant matter to dehydrated plant matter with an % RH of less than about 10%, and removing the dehydrated plant matter from the vacuum chamber.

However, while the vacuum chamber is initially prechilled to 32° F. (0° C.) or below, further cooling may occur to the plant matter is between about −20° F. to about −4° F. before the vacuum chamber is evacuated and/or the initial about 10 hours while under vacuum pressure. This is the primary drying stage. In the secondary drying stage we then exceed 32° F. and up to preferred temp of 55° F. while still under vacuum.

Another aspect of the innovations is characterized by such a process for freeze drying of plant matter wherein the desired frozen plant matter is distributed within the vacuum chamber on one or more shelves and further comprising a step of placing a first temperature sensor in thermal communication with the desired frozen plant matter on the one or more shelves and at least a second thermal sensor directly in thermal communication with the shelves or an internal component of the vacuum chamber in which the step of raising the temperature of the plant matter in the vacuum chamber to not more than 55° F. (12.3° C.) is terminated when the first temperature sensor measures more than 5° F. less than the temperature of the second thermal sensor.

Another aspect of the innovations is characterized by any such process for freeze drying of plant matter in which the plant matter is of the species Cannabis and the removed dehydrated plant matter has a weight of the delta 9 THC is less than 1.5% of the weight of the THC-A.

Another aspect of the innovations is characterized by any such process for freeze drying of plant matter in which the vacuum chamber has a bleed valve that is operatively connected to the controller to be modulated between an at least partially open position and a closed position to maintain a pressure in the vacuum chamber not lower than 500 mTorr and below at least 1500 mTorr.

Another aspect of the innovations is characterized by any such process for freeze drying of plant matter in which the plant matter is one of buds and flowers from a species of cannabis, hops and hemp.

Another aspect of the innovations is characterized by any such process for freeze drying of plant matter wherein the step of raising the temperature in the vacuum chamber to 55° F. (12.3° C.) is completed in 2 or more stages, in which at least one of the stages the temperature in the vacuum chamber is maintained below 32° F. (0° C.) for at least about 10 hours.

Another aspect of the innovations is characterized by any such process for freeze drying of plant matter wherein the step of raising the temperature in the vacuum chamber to 55° F. (12.3° C.) completed in a plurality of stages in which the pressure is maintained below 900 mTorr in a first stage and above 900 mTorr in a second stage, in which the duration of the plurality of stages is at least about 12 hours.

Another aspect of the innovations is characterized by any such process for freeze drying of plant matter that further comprises a step of reacclimating the dehydrated plant matter after removal from the vacuum chamber by exposure to room temperature and atmospheric conditions until the dehydrated plant matter reaches an RH % at between about 5% and 10% and then sealing the dehydrated plant matter in containers.

Another aspect of the innovations is characterized by any such process for freeze drying of plant matter in which the step of reducing the pressure in the vacuum refrigeration chamber for a pre-determined amount of time to sublime frozen water in the plant matter is under a pressure not lower than 500 mTorr and below at least about 1500 mTorr.

Another aspect of the innovations is characterized by any such process for freeze drying of plant matter in which the step of reducing the pressure in the vacuum refrigeration chamber for a pre-determined amount of time to sublime frozen water in plant matter is under a pressure not lower than 720 and not more than about 760 mTorr.

Another aspect of the innovations is characterized by a process for freeze drying of plant matter that comprises the steps of providing frozen plant matter from one of the species of cannabis, hemp and hops; providing a vacuum chamber that is prechilled to receive the frozen plant matter,
introducing the frozen plant matter to the pre-chilled vacuum chamber, reducing the pressure in the vacuum refrigeration chamber for a pre-determined amount of time to sublime frozen water in the frozen plant matter under a pressure not lower than 500 mTorr and below at least 1500 mTorr, maintaining a temperature below 32° F. (0° C.) for a time sufficient t to sublimate ice crystals from a center or core frozen plant matter prior to advancing to the secondary drying or desorption phase to sublimate the ice crystals from the center or core of the bud/biomass prior to advancing a secondary drying phase by raising the temperature in the vacuum chamber less than about 55° F. (20.6° C.), removing dehydrated plant matter from the vacuum chamber.

Another aspect of the innovations is characterized by such a process for freeze drying of plant matter wherein the frozen plant matter is distributed within the vacuum chamber on one or more shelves and further comprising a step of placing a first temperature sensor in thermal communication with the frozen plant matter on the one or more shelves and at least a second thermal sensor directly in thermal communication with the shelves or an internal component of the vacuum chamber in which the step of raising the temperature of the plant matter in the vacuum chamber to less than 55° F. (12.4° C.) is based on the first thermal sensor reaching not less than within about 5° F. of the second thermal sensor.

Another aspect of the innovations is characterized by any such process for freeze drying of plant matter in which the frozen plant matter is from the species Cannabis and the removed dehydrated plant matter has a weight of the delta 9 THC is less than 1.5% of the weight of the THC-A.

Another aspect of the innovations is characterized by any such process for freeze drying of plant matter wherein the step of raising the temperature in the vacuum chamber to 55° F. (12.3° C.) is completed in 2 or more stages, in which in at least one stage the temperature in the vacuum chamber is maintained below 32° F. (0° C.) for at least 10 hours.

Another aspect of the innovations is characterized by any such process for freeze drying of plant matter wherein the step of raising the temperature in the vacuum chamber to 55° F. (12.3° C.) is completed in a plurality of stages in which the pressure is maintained below about 900 mTorr in a first stage and above 900 mTorr in a second stage, in which the plurality of stages have a total duration of at least about 18 hours.

Another aspect of the innovations is characterized by any such process for freeze drying of plant matter in which the vacuum chamber is prechilled to −20° F. (−29° C.) or less before said step of introducing the frozen plant matter to the pre-chilled vacuum chamber.

Another aspect of the innovations is characterized by any such process for freeze drying of plant matter in which the step of reducing the pressure in the vacuum refrigeration chamber for a pre-determined amount of time to sublime the frozen water in the plant matter is under a pressure not lower than 500 mTorr and below at least about 1500 mTorr.

Another aspect of the innovations is characterized by any such process for freeze drying of plant matter in which the step of reducing the pressure in the vacuum refrigeration chamber for a pre-determined amount of time to sublime the frozen water in the plant matter is under a pressure not lower than 720 mTorr and not more than about 1500 mTorr.

Another aspect of the innovations is characterized by any such process for freeze drying of plant matter that further comprises a step of reacclimating the dehydrated plant matter after removal from the vacuum chamber by exposure to room temperature and atmospheric conditions until RH % at between about 5% and 15%, more preferably about 7 to 12%, but more preferably about 8% to 10%, and then sealing the dehydrated or lyophilized plant matter in containers.

Another aspect of the innovations is a process for freeze drying of plant matter that comprises the steps providing frozen plant matter from one of the species of cannabis, hemp and hops, providing a vacuum chamber that is prechilled to receive the frozen plant matter, introducing the frozen plant matter to the pre-chilled vacuum chamber, reducing the pressure in the vacuum refrigeration chamber for a pre-determined amount of time to sublime frozen water in the frozen plant matter under a pressure not lower than 500 mTorr and below at least 1500 mTorr to maintain a temperature below about 32° F. (0° C.) for a time sufficient to reduce the % RH of the frozen plant matter to between about 5% and 15%, preferably about 7 to 12%, but more preferably about 8% to 10%, raising the temperature in the vacuum chamber to 69° F. (20.6° C.), but more preferably not to exceed about 55° F. (12.8° C.) and then removing dehydrated plant matter from the vacuum chamber.

Another aspect of the innovations is any such process for freeze drying of plant matter in which the vacuum chamber that prechilled to below about 32° F. (0° C.), but preferably −20° F. (−29° C.) but most preferably −25° F. (−88° C.) or less before said step of introducing the frozen plant matter to the pre-chilled

Another aspect of the innovations is characterized by an apparatus for freeze drying that comprises a vacuum chamber a refrigerant system configured in thermal communication with the vacuum chamber for reducing the temperature thereof, a heating system configured to raise the temperature within selected portion of the vacuum chamber to raise the temperature of one or more trays for containing plant matter, a vacuum pump in fluid communication with the vacuum chamber, a pressure sensor configured to measure the vacuum within one of the vacuum chamber and between the vacuum chamber and the vacuum pump, a first temperature sensor for configured for making proximal contact with plant matter to be freeze dried within the vacuum chamber, a second temperature sensor for configured for being in thermal communication with an interior portion of the vacuum chamber that is remote from the plant matter to be freeze dried within the vacuum chamber, a controller that is operative to energize and de-energize at least one of the vacuum pump, heating systems and refrigerant system in response to signals received from the pressure sensor, first and second temperature sensors.

Another aspect of the innovations is characterized by an apparatus for freeze drying further comprising a bleed valve that is operatively connected to the controller that is programmed to modulate the valve between an at least partially open and closed position to maintain a vacuum chamber pressure not lower than 500 mTorr and below at least 1500 mTorr when the refrigerant system and heating system are energized.

Another aspect of the innovations is characterized by any such apparatus for freeze drying in which the controller is programmed to raise the temperature of plant matter in the vacuum chamber by energizing the heating system in 2 or more stages, in which at least one stage the temperature of the plant matter is maintained below 32° F. (0° C.) for at least 10 hours.

Another aspect of the innovations is characterized by any such apparatus for freeze drying in which the controller is programmed to maintain the pressure in the vacuum chamber for one of a pre-determined amount of time and until the RH % of the plant matter is below at about 10% during which frozen water in plant matter is sublimed at vacuum chamber pressure not lower than about 720 mTorr and not more than about 1500 mTorr.

Another aspect of the innovations is characterized by any such apparatus for freeze drying further comprising a relative humidity sensor configured for making proximal contact for matter to be freeze dried within the vacuum chamber in which the controller is operative to energize and de-energize at least one of the vacuum pump, heating systems and refrigerant system in response to signals received from the humidity sensor.

The above and other objects, effects, features, and advantages of the present innovations will become more apparent from the following description of the embodiments thereof taken in conjunction with the accompanying drawings.

### BRIEF DESCRIPTION OF DRAWINGS

FIG. 1 is a schematic diagram of an apparatus for carrying out various aspects of innovative processes.

FIG. 2 is a schematic diagram of another embodiment of an apparatus for carrying out various aspects of the innovative processes.

FIG. 3 is a flow chart of one embodiment of the innovative processes.

FIG. 4 is a flow chart of another embodiment of the innovative processes.

FIGS. 5A and 5B are timing diagrams showing temperatures and pressure stages in one implementation of the freeze-drying process.

FIG. 6 is a timing diagram showing temperatures and pressure stages in another implementation of the freeze-drying process.

FIG. 7 is a timing diagram showing temperatures and pressure stages in another implementation of the freeze-drying process.

### DETAILED DESCRIPTION

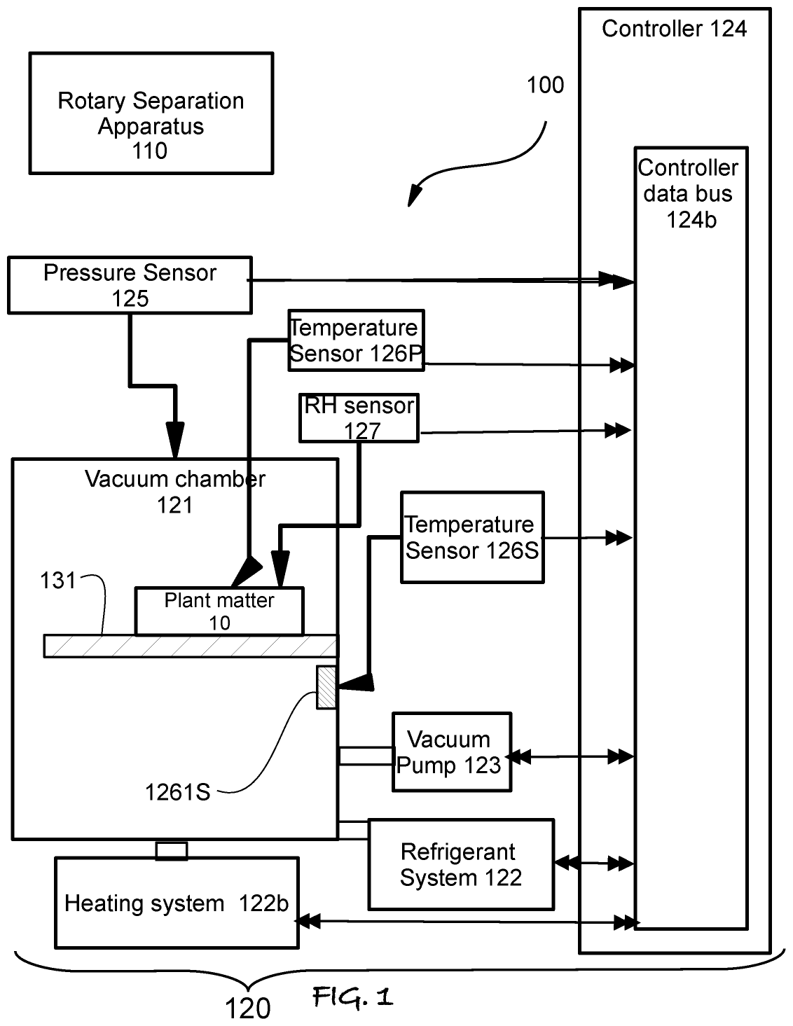

Referring to FIGS. 1 through 7, wherein like reference numerals refer to like components in the various views, there is illustrated therein a new and improved process 1000 for freeze drying of plant matter, generally denominated 1000 herein, which may deploy the apparatus 100 and along with a freeze-drying system 120.

In accordance an aspect of the present innovations a process 1000 for freeze drying of plant matter comprises the steps of freezing the plant matter with a liquid freezing agent at atmospheric pressure, removing a desired portion of the frozen plant matter to a vacuum refrigeration chamber 121, reducing the pressure in the vacuum refrigeration chamber for a pre-determined amount of time to sublime frozen water in the plant matter under a pressure not lower than 500 mTorr, and not higher than 1500 mTorr, while raising the temperature in the vacuum chamber before gradually venting when excess water is removed to provide a stable dehydrated plant product. The liquid freezing agent is preferably inert, such as liquid nitrogen, liquid carbon dioxide (CO2) or any other inert or noble gas.

In the case of processing cannabis plants using variants of the process 1000, it has been discovered that optimal conditions and equipment are necessary to avoid loss of product quality, such as from infestation of mold and mildew, loss of linear or monoterpenes, loss of cannabinoids, loss of terpenes, discoloration of flowers, darkening of extracts. There is a narrow range of optimal moisture levels in the final product. In the case of drying cannabis buds or flowers excess removal of water can produce fragile product that can readily transform to a dust when handled. However, if insufficient water is removed the product can have a consistency and undesired aroma of wet hay. When linear terpene or mono-terpenes are lost the product lacks the desired aroma and flavonoids expected by consumers.

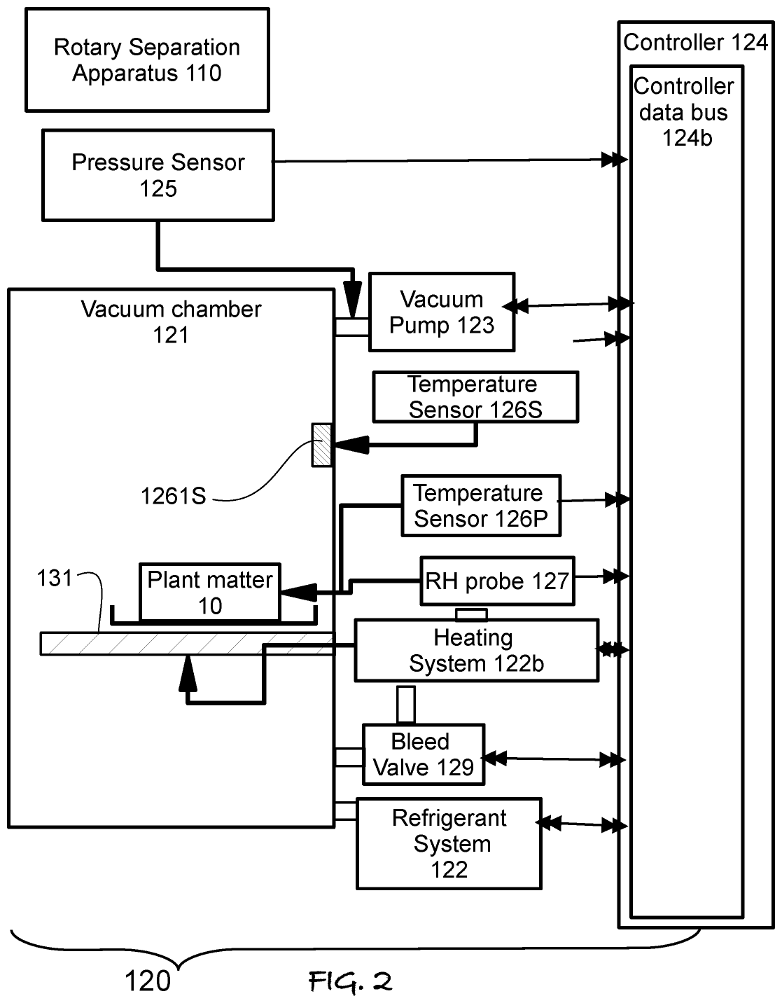

It has been discovered that with the innovative equipment configurations of FIGS. 1 and 2, and the process conditions described further below result in a higher quality and value Cannabis products.

Accordingly, benefits of the innovative apparatus and process are preserving a greater amount of the native cannabinoids and terpenes including THC, CBD, CBN, CBG & CBC among others, than any other drying method. Another benefit is that the freeze-dried plant matter is stable and additional processes may then be deployed to separate linear or mono-terpenes from polycyclic plant terpenes and terpenoids, such as cannabinoids, or distinct species of cannabinoids from each other. Typically, Cannabis plants are hung up after harvest to dry in air 14-30 days. During this drying process the plant enzymes that cause plant senescence deteriorate as they slowly degrade the chlorophyll. The full removal of chlorophyll is necessary to remove the “green” or grassy taste when the product is consumed by smoking. However, as moisture is removed slowly, the drying plants can still be attacked by fungus or molds.

Removing moisture more rapidly by freeze drying prevents degradation of such compounds, improves the shelf life, and produces final products may be more potent as cannabinoids, terpenes, terpenoids and also flavonoids are retained in the process. The products are more potent, being on average 3 to 4% higher in total cannabinoids than traditionally dried and cured products. As terpenes, terpenoids and flavonoids compounds are neither lost nor degraded in the process, the final product has superior fragrance and taste, as well as more predictable medicinal and therapeutic benefits. Further, freeze drying cannabis prevents deterioration of THC-A, which when decarboxylated, converts into Delta-9 THC & CBN, which are the cannabinoids responsible for making users feel drowsy or lethargic. Further the consumer of the products by smoking have minimized tussiculation (coughing) and smoother inhalation as compared to smoking traditionally dried and cured cannabis. Another aspect of the freeze drying process 1000 for the species Cannabis and the removed dehydrated plant matter dehydrated plant matter comprises primarily THC-A, in which the weight of the delta 9 THC is less than 1.5% of the weight of the THC-A, which is calculated by dividing the mass of delta 9 THC in a samples by the mass of THC-A in the sample and multiply by 100. Absent this process, conventional drying results in ratios of about 3.7 or higher.

Other more preferred aspects of the process may include additional steps or process conditions as follows or in the Appendix to this application, which are submitted herewith, being incorporated herein by reference.

The basic principle of freeze-drying cannabis, hemp or other plants is the removal of water from plant matter 10 as water vapor through sublimation of frozen ice crystals or otherwise bound water molecules. With the biomass or plant matter 10 solidly frozen during the process, and under a deep vacuum, shrinkage is eliminated, and near perfect preservation of the bud and flower shape and appearance can be achieved. This process is also known as lyophilization.

The innovative apparatus 100 and process 1000 can be used to separate, and freeze dry a wide range and type of materials. Many plant and herb species have the highest concentrations of terpene and cyclic terpene compounds with aromatic and medicinal properties in the flowering portions of the plant, and in particular in glandular or secreting trichomes.

The flowers typically form at the tips of growing plant shoots. The flowers, flower buds and leaves have hair like outgrowths that are referred to as trichomes. These trichomes, being glandular secrete plant resins as a small bulb or head at the end of a stalk like hair.

The various embodiments of the process 1000 are particularly useful for processing hemp and cannabis plants that contain both linear terpenes and cyclic terpenes in the form of cannabinoids and is likely beneficial in processing other plants with a high concentration of trichomes in the flowers or buds, such as hop plants, in which the flowers and buds contain important flavoring compounds for beer brewing. The various embodiments of the process 1000 are also useful in removing water from plant matter 10 that is primarily the trichomes that contain the highest concentration of terpene and cyclic terpene compounds, which depending on the plant species, such as by mechanical agitation with or without cryo-processing.

Another object of the innovations is to rapidly process the buds and flowers in a manner that produces a shelf stable product of high quality, preserving color, flavor and aroma, as well as the desired chemical species. The tips of growing plants that are beginning the flowering process may have multiple flower buds or flowers interspersed with fine leaves. These fine leaves are known as bracts and bracteoles. In the case of cannabis and related species, such as hops, the flower region may contain multiple buds, also known as calyxes, as well as pistils, seeds, bracts and bracteoles. The bracts and bracteoles in Cannabis are referred to as sugar leaves. While the sugar leaves have higher concentrations of trichomes and the desirable resins than larger or bigger leaves, often referred to as palm leaves, which are lower down the shoots from the flower region, the highest density of trichomes and hence concentration of resins are in the calyx's and pistils of the flowers and buds. Thus, it is desirable in processing Cannabis plants to isolate the flowers from plants, but remove the seeds, if any, and sugar leaves. These sugar leaves, when removed or “trimmed” are frequently referred to as “trim”. Another aspect of the innovations is a method of rapidly removing the “trim” or “trimming” while leaving the other desirable portions of the plant, which is the flower and buds largely intact.

A preferred way to process cannabis, hemp, hops and other plants to remove plant matter, such as sugar leaves, that does not contain significant trichome content is to rapidly freeze freshly harvested plants, using an inert freezing agent like liquid CO2 or liquid nitrogen, as in the patented Cryo-Trim® process which is disclosed in commonly owned U.S. Pat. Nos. 10,507,223B2 and 10,512,938B2, which are incorporated herein by reference, which may deploy an apparatus referred to herein as a rotary separation apparatus 110.

The innovative apparatus 100 according to one teaching of the current innovations is the rotary separation apparatus 110 used in conjunction with the freeze-drying system 120. The freeze-drying system 120 of FIGS. 1 and 2 deploys a vacuum chamber 121 for receiving the product of the rotary separation apparatus 110. The temperature in the vacuum chamber 121 is reduced by a refrigerant system 122. The refrigerant system 122 and the vacuum pump 123 are energized by a controller 124 that is preferably responsive to one or more of the pressure sensors 125, one or more temperature sensors 126 and preferably a relative humidity (RH) sensor 127 in the vacuum chamber 121 that is in proximal contact with the plant matter 10 during the drying process. The vacuum chamber 121 preferably includes internal and or external insulation between the portions cooled directly or indirectly by the refrigeration system 112, such as outside a jacket circulating refrigerant fluid or inside or outside of a glass or transparent door on the vacuum chamber 121. The vacuum chamber also has at least one vent port to admit air when the process is completed and may include a drainage port or line to remove water from the melting ice that build up inside the chamber interior walls that are in thermal communication with the circulating refrigerant. Alternatively, if the freeze-drying system 120 deploys a water condensing cold trap between the vacuum pump(s) and the vacuum chamber 121, then a drain line may not be required.

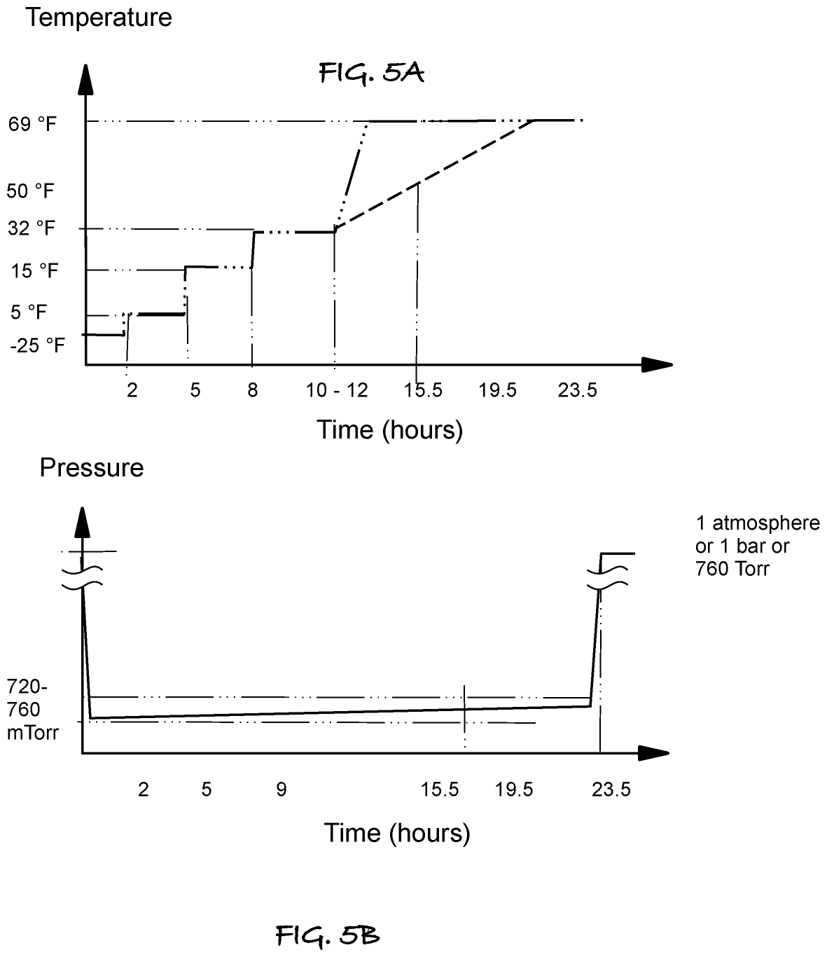

The controller 124 is optionally a microprocessor, programmable logic controller or similar computing device that can be configured to be operative in response to a program in which the controller 124 receives signals from the pressure sensor 125, temperature sensor 126P, temperature sensor 126S and RH sensor 127 and either proportionally or discretely energizes and deenergizes the refrigeration system 122, at least one vacuum pump(s) 123 and a heater system 122b to provide the conditions of pressure and temperature indicated in FIG. 5A to FIG. 7, and as otherwise described herein, as well as the optional bleed valve 129. The pressure sensor 125 may be in direct fluid communication with the vacuum chamber 121 or a conduit forming the fluid communication between the vacuum pump(s) 123 and the vacuum chamber 121.

As the plant matter 10 is preferably placed in uniform layers within trays 132 that can removably mounted on shelves or shelve brackets 131 within the vacuum chamber 121, the heating elements of the heating system 122b are ideally dispersed to be proximal to the shelves 131 or shelf brackets 131 to gradually warm the trays 132, rather than heat the vacuum chamber 121 interior walls which are cooled by a circulating refrigerant from the refrigeration system 122. The controller program may provide proportional control via a proportional-integral-derivative (PID) control scheme, a proportional-derivative (PD) control scheme, and the like. A non-limiting example of a device having a sensor to measure the RH % of the plant matter 10 directly during the process is the Elitech GSP-6 Temperature and Humidity Data Logger Recorder, which is available from Elitech Corp. of 1551 McCarthy Blvd, Suite 112, Milpitas, CA. The controller 124 may also include a memory module, user interface and output module or datalogger to record the actual process conditions and is energized by an external power source. Thus, the controller 124 is operative to switch and modulate power from an external source to the refrigeration system 122, vacuum pump(s) 123 and chamber heater system 122b. The controller 124 may deploy a bus architecture in which the signal from the pressure sensor 125, temperature sensor 126P, temperature sensor 126S and RH sensor 127 are sent to the controller bus 124b and the same or another controller bus or subcomponent modulates the energy to the refrigeration system 122, vacuum pump(s) 123 and chamber heater system 122b.

The following documents, all of which are incorporated herein by reference, disclose further details and alternative configurations for freeze drying systems that may be utilized with the innovative processes disclosed herein: U.S. Pat. No. 10,976,104 B2 issued to Dern, C. D. on Apr. 13, 2021; U.S. Pat. No. 10,900,713 B2 issued to Gong, M. et al on Jan. 26, 2021; U.S. Pat. No. 10,690,410 B2 issued to Tsubata, K. et al. on Jun. 23, 2020; U.S. Pat. No. 10,309,723 B2 issued to Tsubata, K. et al. on Jun. 4, 2019; U.S. Pat. No. 9,879,909 B2 issued to Fissore, D. et al. on Jan. 30, 2018; U.S. Pat. No. 8,793,895B2 issued to Gasteyer III, T. H. on Aug. 5, 2014; U.S. Pat. No. 7,347,0004B1 issued to Halvorsen, M. J. on Jan. 13, 2008; U.S. Pat. No. 6,543,155 B2 issued to Horigone, A. on Apr. 8, 2003; U.S. Pat. No. 5,884,413A issued to Anger, A. R. on Mar. 23, 1999; U.S. Pat. No. 5,884,414A issued to Anger, A. R. on Mar. 23, 1999; U.S. Pat. No. 5,822,882A issued to Anger, A. R. on Oct. 20, 1998; U.S. Pat. No. 4,949,473A issued to Steinkamp, H. on Aug. 21, 1990; and U.S. Pat. No. 3,401,466A issued to Brewster, M. L. on Sep. 17, 1968. U.S. Pat. No. 4,177,577A and 4,173,078A issued to Bird H. L. on December 12 and November 6 of 1979 respectively discloses shelf arrangements in a freeze dryer. U.S. Pat. No. 9,170,049 B2 issued to Fissore, D. et al. on Oct. 27, 2015, discloses a method of monitoring a freeze-drying process, as does U.S. Pat. No. 8,800,162 B2, which was issued to Velardi, S. et al. on Aug. 12, 2014. U.S. Pat. No. 9,121,637 B2 issued to Ling, W. on Sep. 1, 2015, also discloses a method to monitor and control a freeze-drying process. U.S. Pat. No. 4,780,964A issued to Thompson, T. N. on Nov. 30, 1987, discloses a method of determining stages of freeze-drying frozen product on shelves. A cannabis freeze drying machine is disclosed in US Pat. Application No. US20210018263A1 (Inventor Sheridan, D. E. et al.), which published on Jan. 21, 2021

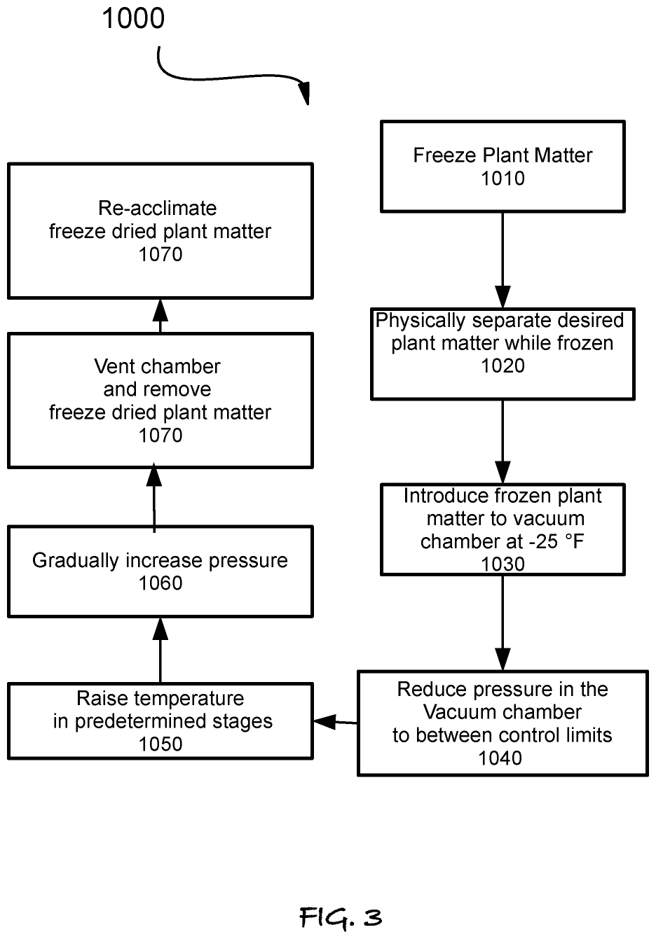

To the extent the vacuum pump 123 is not capable of stable control under optimum freeze-drying conditions, a more preferred apparatus 1000 is illustrated in FIG. 2. In this embodiment, the controller 124 is operative to modulate the condition of a bleed valve 129 to the vacuum chamber 121, which using the output of pressure sensor 125 is deployed to keep the pressure within pre-determined control limits in the process 1000, as illustrated by a flow chart in FIG. 3, at step 1040.

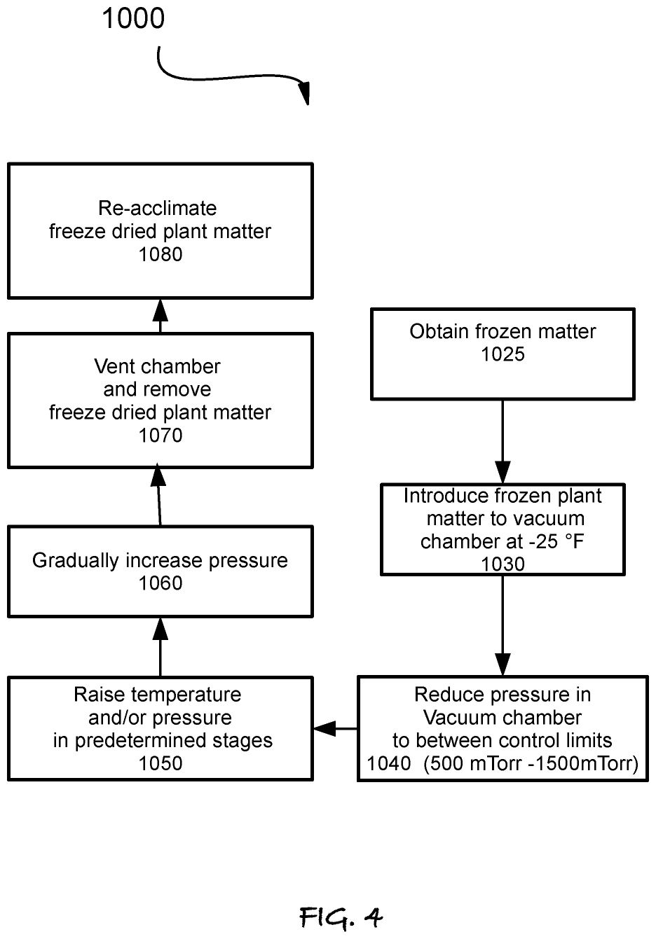

In this process 1000, the plant matter is frozen in step 1010 before a physical separation in step 1020, which removes by size and/or density filtration undesired leaves and other plant matter, such as sugar leaves, that fragments in the rotary separation apparatus 110. The physical separation in step 1020 optionally uses the aforementioned rotary separation apparatus 110, but may use equivalents thereto, including those described in the U.S. Pat. Nos. 10,507,223B2 and 10,512,938B2. The desired plant matter 10, usually the flower and buds that are rich in trichome containing aromatic compounds, are then removed while still below about 32° F. (0° C.)(so the water content is still frozen) placed in the pre-chilled vacuum chamber 121 that is preferably at about −25° F. (−88° C.) (step 1030). Alternatively, frozen plant matter 10 can be obtained in the process illustrated in FIG. 4 in step 1025, and then placed in the pre-chilled vacuum chamber 121 that is preferably at about −25° F. (−88° C.) (step 1030). The frozen plant matter 10 can be stored for at least up to 2 years before the various methods of freeze drying described herein. The vacuum pump 123 is energized by the controller 124 to reduce the pressure in the vacuum chamber 121 to within control limits of greater than about 500 mTorr (milliTorr) to less than about 1500 mTorr. More preferably, when presented with equipment limitations, these limits may bay be between about 720 mTorr to 760 mTorr in step 1040. FIG. 1 illustrates a configuration in which a first temperature sensor 126P has a probe imbedded in the plant matter 10. A second temperature sensor 126S uses a probe that measures the vacuum chamber temperature with a probe in thermal communication with a portion of the vacuum chamber distal from the plant matter 10, such as a shelf 131 in the vacuum chamber 121 or the chamber interior wall. Plant matter 10 is also disposed on at least one shelf 131, but the probe of thermal sensor 1261S is placed on a portion of such a shelf 131 remote from the plant matter 10. It should be understood that if the plant matter 10 is not immediately placed in such a pre-chilled vacuum chamber 121 after it is frozen in a prior process step, such as for separation of trichomes or removal of sugar leaves from buds and flowers, the plant matter 10 is preferably stored in freezers below about 0° F. (−17.8° C.) before the start of the dehydration in the pre-chilled vacuum chamber 121.

FIG. 5A to 7 illustrate alternative implementations of the vacuum chamber 121 temperature and pressure conditions during the freeze-drying process 1000 in steps 1040, 1050 and 1060. After step 1070 the freeze-dried plant matter 10 removed from the vacuum chamber 121 is not so dry as to be unacceptably fragile or friable from under drying in which the plant structure collapses and re-absorbs excessive moisture that can result in spoilage. It has been discovered that when the product 10 at step 1070 have more than 0% RH up to about 10% RH, but preferably between 5% RH to about 10% RH is most suitable for the acclimation step 1080.

I have discovered alternative implementations to accomplish the result of achieving an end product with 5-10% RH, as well as the more preferably range of 8-10% RH. The final acclimation step 1080 before packaging is to reacclimatize the freeze-dried product to a stable state. It should be noted that as a preferred aspect of the apparatus 100 and/or process 1000 may deploy the Cryo-Trim® process or an equivalent, the cell walls in the flower and buds are already disrupted by the growth of ice crystals in freshly harvested plants. This allows the biomass or plant matter 10 to absorb more moisture from the air, unless kept cold until introduced into the chilled vacuum chamber 121 of the freeze dryer 120. When freeze dried cannabis, hemp or hops, that is product 10, comes out of the vacuum chamber 121 after step 1070 and is exposed to sufficient oxygen in the air, the atmospheric or added moisture allows still active plant enzymes to degrade the chlorophyll in only about 1-8 hours (depending on the final humidity level). This yields a product equivalent in the removal of chlorophyll to traditionally dried buds and flower that have been cured for 14-30 days. Allowing the removed product to acclimate in a climate-controlled environment of about 70° F. (21.1° C.) and 60% RH or alternatively kept in a humidor or a bin/tote with lid and 50% RH level moisture packs, results in an end product that is more shelf stable and ready for consumption and has a longer life when sealed in packaging. The end product may be sealed in packaging at about 5-10% RH, but more preferably at about 8-10% RH. When the product is optimally sealed in packaging at about 8-10% RH it will then remain stable and free of fungal or mold growth for a considerable time. Such optimal sealing can be under vacuum to exclude further air and moisture.

In the implementation of steps 1040, 1050 and 1060 illustrated in embodiment of the process 1000 in FIGS. 5A and 5B, the temperature is increased in steps while the pressure in the vacuum chamber 121 is maintained at between about 720 mTorr to about 1400 mTorr, and may be preferable between about 850-1,000 mTorr depending on size and stability of the pumping and control system of the freeze dryer.

During about the first 12 hours the temperature is at or below the freezing point of water (32° F. (0° C.) or zero degrees C.) so that ice crystal are sublimed before the temperature is raised upward either gradually (dashed line in FIG. 5A) or in steps (dash-dot-dot-dot line) to not exceed 69° F. (20.6° C.), but more preferably about 55° F. (12.3° C.) in a second phase that may be completed in 16 to 19 hours, but generally by 20 to 24 hours. The plant matter 10 in the vacuum chamber 121 then reaches a conditions when it has a RH % of 0 to 10%. This RH % is usually reached when the chamber temperature, as measured by the temperature sensor 126S with the associated probe thereof in thermal communication or contact with internal components like shelves 131, is the same as the temperature sensor 126P with the probe thereof contacting the plant matter 10 to be dehydrated. More specifically, when the product temperature probes are lower than but within about 5° F. of the preferred setting of 55° F. shelf temp, it has been discovered this will generally result in an overdried product with less than 5% RH. Alternatively, an RH meter can contact the plant matter 10 to be dehydrated as an additional means to monitor the progress of de-hydration process. It is also preferable to also use an RH meter to test the dehydrated plant matter 10 % RH after the vacuum chamber 121 is vented to atmosphere, as well as before packaging. Hence, is preferably to vent the vacuum chamber 121 when the product temperature probe 126S is less than about 50° F., but more preferably between about 45° F. to about 50° F., and then remove the product 10. The product 10 at this stage generally has a sufficient humidity that the desired final acclimation step 1080 occurs predicably in 1-8 hours so the final product 10 is ready for packaging.

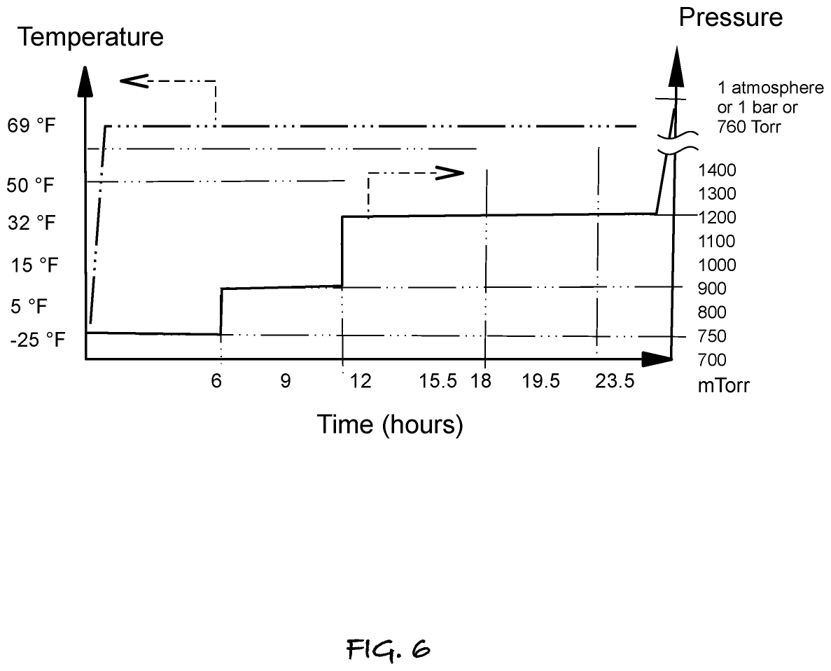

In the implementation of steps 1040, 1050 and 1060 in an alternative embodiment illustrated in FIG. 6 the pressure is raised in stages from generally not less than about 500 mTorr, but more preferably greater than about 720 mTorr, while the product is rapidly brought not to exceed about 69° F. (20.6° C.), but more preferably 55° F. (12.3° C.) when this initial pressure is reached. During about the first 12 hours the plant product temperature as measured by a thermal probe or sensor 126S remains at a temperature well below the freezing point of water until the ice crystals are sublimed. This time is generally sufficient to sublimate the ice crystals from the center or core of the bud/biomass with the product 10 prior to advancing to the secondary drying or desorption phase, during which the pressure can be raised to between about 850 mTorr to about 1400 mTorr for the remaining 6 to 10 hours, for a total elapsed time of 18 to 24 hours. However, on occasion as the total elapsed time may extend to about 26-30 hours depending on the nature of the product 10 to be dried, such as the bud density and the loading of the vacuum chamber 121. When the temperature sensor 126P measuring plant product 10 temperature directly reaches within between about 5° F. to 10° F. of the shelf or chamber as indicated by temperature sensor 125S, the vacuum chamber 121 may be fully vented to atmosphere to remove the dried plant product 10. If this temperature difference is less than about 5° F. then the product RH % is usually less than about 5%, hence it more desirable to terminate the process at a greater difference than about 5° F. so the final product % RH is in a more preferable range of 5% to 10% RH.

When the product 10 is held to less than or about 55° F. (12.3° C.) during the variance variants of the process 100, there are several benefits. First, the most volatile terpenes and flavonoids are maintained at the same levels as conventional slow drying. Further, the process 100 preserves the shape and size of the flowers and buds, as there is essentially no shrinkage. The color and flavor is maintained, and the resulting product is still very stable and can be stored for a considerably longer time than conventionally dried products, with risk of spoilage. Under these conditions the product 10 is generally free of delta 9 THC, in that less than about 2% of the THC-A has been converted to delta 9 THC.

Suitable freeze dryers can be obtained from Harvest Right, 95 North Foxboro Drive, Ste. 100, North Salt Lake, UT 84054. Alternative configurations of freeze dryers may be used, but preferably deploy in the vacuum system an oil free scroll pump.

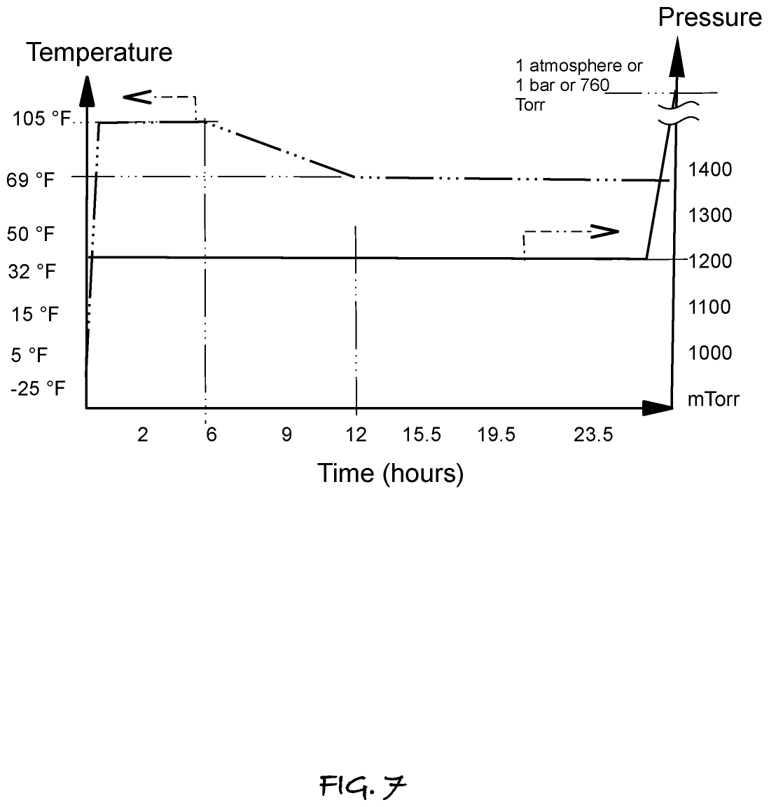

In the implementation of steps 1040, 1050 and 1060 in the embodiment of the process 1000 illustrated in FIG. 7 the pressure is initially brought to and maintained at about 1,200 mTorr with an initial rise of the chamber temperature from about −25° F. (−88° C.) to about 105° F., which is preferably as fast at the freeze drying system 120 will permits without overshooting the temperature and/or pressure and then maintaining at this temperature for about 6 hours. Then the temperature of the vacuum chamber 121 is gradually reduced to about 69° F. (20.6° C.), but more preferably 55° F. (12.3° C.) over the next 6 hours, for a total 12 hours. During about the first 12 hours the thermal sensor 126P or probe thereof in contact or thermal communication with the frozen plant matter 10 remains at a temperature well below the freezing point of water until the ice crystals are sublimed. During the remaining hours the residual moisture that is absorbed in the plant matter 10 and not in the form of ice crystals is gradually removed. When a temperature sensor 126P with a probe thereof measuring product temperature reaches to within more than about 5° F. of shelf or chamber temperature sensor 126S measurement this may constitute the final stage of dehydration, the vacuum chamber 121 may then be fully vented to atmosphere to remove the product, as the RH % is then usually greater about 5% but also below about 10% RH.

The implementation of steps 1040, 1050 and 1060 as illustrated in FIG. 6 and FIG. 7 is more suitable for commercial freeze-drying equipment in which one or more vacuum pumps 123 and refrigeration system 122 are of adequate capacity and sufficiently stable to readily for the controller 124 to maintain a pressure within the chamber of between about 500 to 1500 mTorr, but more preferably 720 to 1400 mTorr, and more preferably 850 to 1000 mTorr. The implementation of FIGS. 5A and 5B may be used with less capable equipment if provided with the bleed valve 129 or its equivalent to maintain the vacuum level at the more preferred ranges as the temperature is gradually raised in steps or the equivalent, such as a gradual rise or increase. In the implementation of FIGS. 5A and 5B the controller 124 is operative to open the bleed valve 129 to admit outside air in the vacuum chamber 121 at low rates to maintain the pressure about a lower limit and close the bleed valve 129 when the pressure is reaching or about to overshoot an upper control limit. This additional control required by the bleed valve 129 may be required because the rate of sublimation of frozen water, which raises the vacuum chamber pressure, may be uneven or chaotic because of the nature of the plant matter and how it packs down on the shelves 131 in the freeze-drying process 1000. The sublimation rates may also be uneven or chaotic because of capacity and control of the refrigerant system 122 or heating system 122b.

These implementations have all been successful in preserving at the original concentration and ratio of the linear and mono terpenes in the final product, as such that when consumed it has the desired aroma and other benefits expected by consumers. Additional benefits that may be desired are reduced levels of delta 9 THC and CBN, and other psychoactive cannabinoid compounds in the final dehydrated product.

In addition, if it is desired to extract pure cannabinoids or other terpene or cyclic terpene compounds from plant matter 10 after freeze drying these processes are further improved by the elimination of water.

It should be understood the use of the word “About” generally refers to a variation of +/1 10%, unless from the context of use that a smaller or larger variation may be tolerated to achieve a desired result.

While the innovations have been described in connection with several preferred embodiment, it is not intended to limit the scope of the protection to the particular form set forth, but on the contrary, it is intended to cover such alternatives, modifications, and equivalents as may be within the spirit and scope of the innovations as defined by the appended claims.

I claim:

1. A process for freeze drying of plant matter that comprises the steps of:
a. freezing the plant matter with a liquid freezing agent at atmospheric pressure to one of fragments undesired plant matter and to dislodge desired plant matter such that desired plant matter remains on a sieving member, with the fragmented plant matter passing through the sieving member,
b. removing the desired plant matter from the sieving member while frozen,
c. providing one of a storage and a vacuum chamber that is prechilled to at or 32° F. (0° C.) below to receive the desired frozen plant matter from the sieving member,
d. introducing the desired frozen plant matter to the pre-chilled vacuum chamber,
e. reducing the pressure in the vacuum chamber for a pre-determined amount of time to sublime frozen water in the plant matter under a pressure not lower than 500 mTorr and below at least 1500 mTorr,
f. maintaining the plant matter at temperature below about 32° F. (0° C.) until the pressure in the vacuum chamber is reduced to below at least about below at least 1500 mTorr,
g. raising the temperature of the plant matter in the vacuum chamber to not more than 55° F. (12.3° C.) in one or more stages to convert the plant matter to dehydrated plant matter with an % RH of less than about 10%,
h. removing the dehydrated plant matter from the vacuum chamber.

2. The process for freeze drying of plant matter according to claim 1 wherein the desired frozen plant matter is distributed within the vacuum chamber on one or more shelves and further comprising a step of placing a first temperature sensor in thermal communication with the desired frozen plant matter on the one or more shelves and at least a second thermal sensor directly in thermal communication with the shelves or an internal component of the vacuum chamber in which the step of raising the temperature of the plant matter in the vacuum chamber to not more than 55° F. (12.3° C.) is terminated when the first temperature sensor measures more than 5° F. less than the temperature of the second thermal sensor.

3. The process for freeze drying of plant matter according to claim 2 in which the plant matter is of the species Cannabis and the removed dehydrated plant matter has a weight of the delta 9 THC is less than 1.5% of the weight of the THC-A.

4. The process for freeze drying of plant matter according to claim 1 in which the vacuum chamber has a bleed valve that is operatively connected to the controller to be modulated between an at least partially open position and a closed position to maintain a pressure in the vacuum chamber not lower than 500 mTorr and below at least 1500 mTorr.

5. The process for freeze drying of plant matter according to claim 1 in which the plant matter is one of buds and flowers from a species of cannabis, hops and hemp.

6. The process for freeze drying of plant matter according to claim 1 wherein the step of raising the temperature in the vacuum chamber to 55° F. (12.3° C.) is completed in 2 or more stages, in which at least one of the stages the temperature in the vacuum chamber is maintained below 32° F. (0° C.) for at least about 10 hours.

7. The process for freeze drying of plant matter according to claim 1 wherein the step of raising the temperature in the vacuum chamber to 55° F. (12.3° C.) completed in a plurality of stages in which the pressure is maintained below 900 mTorr in a first stage and above 900 mTorr in a second stage, in which the duration of the plurality of stages is at least about 12 hours.

8. The process for freeze drying of plant matter according to claim 2 that further comprises a step of reacclimating the dehydrated plant matter after removal from the vacuum chamber by exposure to room temperature and atmospheric conditions until the dehydrated plant matter reaches an RH % at between about 5% and 10% and then sealing the dehydrated plant matter in containers.

9. The process for freeze drying of plant matter according to claim 1 in which the step of reducing the pressure in the vacuum refrigeration chamber for a pre-determined amount of time to sublime frozen water in the plant matter is under a pressure not lower than 500 mTorr and below at least about 1500 mTorr.

10. The process for freeze drying of plant matter according to claim 1 in which the step of reducing the pressure in the vacuum refrigeration chamber for a pre-determined amount of time to sublime frozen water in plant matter is under a pressure not lower than 720 and not more than about 760 mTorr.

11. A process for freeze drying of plant matter that comprises the steps of:
a. providing frozen plant matter from one of the species of cannabis, hemp and hops,
b. providing a vacuum chamber that is prechilled to receive the frozen plant matter,
c. introducing the frozen plant matter to the pre-chilled vacuum chamber,
d. reducing the pressure in the vacuum refrigeration chamber for a pre-determined amount of time to sublime frozen water in the frozen plant matter under a pressure not lower than 500 mTorr and below at least 1500 mTorr,
e. maintaining a temperature below 32° F. (0° C.) for a time sufficient t to sublimate ice crystals from a center or core frozen plant matter prior to advancing to the secondary drying or desorption phase. o sublimate the ice crystals from the center or core of the bud/biomass prior to advancing a secondary drying phase by raising the temperature in the vacuum chamber less than about 55° F. (20.6° C.),
f. removing dehydrated plant matter from the vacuum chamber.

12. The process for freeze drying of plant matter according to claim 11 wherein the frozen plant matter is distributed within the vacuum chamber on one or more shelves and further comprising a step of placing a first temperature sensor in thermal communication with the frozen plant matter on the one or more shelves and at least a second thermal sensor directly in thermal communication with the shelves or an internal component of the vacuum chamber in which the step of raising the temperature of the plant matter in the vacuum chamber to less than 55° F. (12.4° C.) is based on the first thermal sensor reaching not less than within about 5° F. of the second thermal sensor.

13. The process for freeze drying of plant matter according to claim 11 in which the frozen plant matter is from the species Cannabis and the removed dehydrated plant matter has a weight of the delta 9 THC is less than 1.5% of the weight of the THC-A.

14. The process for freeze drying of plant matter according to claim 11 wherein the step of raising the temperature in the vacuum chamber to 55° F. (12.3° C.) is completed in 2 or more stages, in which in at least one stage the temperature in the vacuum chamber is maintained below 32° F. (0° C.) for at least 10 hours.

15. The process for freeze drying of plant matter according to claim 11 wherein the step of raising the temperature in the vacuum chamber to 55° F. (12.3° C.) is completed in a plurality of stages in which the pressure is maintained below about 900 mTorr in a first stage and above 900 mTorr in a second stage, in which the plurality of stages have a total duration of at least about 18 hours.

16. The process for freeze drying of plant matter according to claim 11 in which the vacuum chamber is prechilled to −20° F. (−29° C.) or less before said step of introducing the frozen plant matter to the pre-chilled vacuum chamber.

17. The process for freeze drying of plant matter according to claim 11 in which the step of reducing the pressure in the vacuum refrigeration chamber for a pre-determined amount of time to sublime the frozen water in the plant matter is under a pressure not lower than 500 mTorr and below at least about 1500 mTorr.

18. The process for freeze drying of plant matter according to claim 11 in which the step of reducing the pressure in the vacuum refrigeration chamber for a pre-determined amount of time to sublime the frozen water in the plant matter is under a pressure not lower than 720 mTorr and not more than about 1500 mTorr.

19. An apparatus for freeze drying that comprises:
a. a vacuum chamber
b. a refrigerant system configured in thermal communication with the vacuum chamber for reducing the temperature thereof,
c. a heating system configured to raise the temperature within selected portion of the vacuum chamber to raise the temperature of one or more trays for containing plant matter,
d. a vacuum pump in fluid communication with the vacuum chamber,
e. a pressure sensor configured to measure the vacuum within one of the vacuum chamber and between the vacuum chamber and the vacuum pump,
f. a first temperature sensor for configured for making proximal contact with plant matter to be freeze dried within the vacuum chamber,
g. a second temperature sensor for configured for being in thermal communication with an interior portion of the vacuum chamber that is remote from the plant matter to be freeze dried within the vacuum chamber,
h. a controller that is operative to energize and de-energize at least one of the vacuum pump, heating systems and refrigerant system in response to signals received from the pressure sensor, first and second temperature sensors.

20. The apparatus for freeze drying according to claim 19 further comprising a bleed valve that is operatively connected to the controller that is programmed to modulate the valve between an at least partially open and closed position to maintain a vacuum chamber pressure not lower than 500 mTorr and below at least 1500 mTorr when the refrigerant system and heating system are energized.

21. The apparatus for freeze drying according to claim 19 in which the controller is programmed to raise the temperature of plant matter in the vacuum chamber by energizing the heating system in 2 or more stages, in which at least one stage the temperature of the plant matter is maintained below 32° F. (0° C.) for at least 10 hours.

22. The apparatus for freeze drying according to claim 19 in which the controller is programmed to maintain the pressure in the vacuum chamber for one of a pre-determined amount of time and until the RH % of the plant matter is below at about 10% during which frozen water in plant matter is sublimed at vacuum chamber pressure not lower than about 720 mTorr and not more than about 1500 mTorr.

23. The apparatus for freeze drying according to claim 19 further comprising a relative humidity sensor configured for making proximal contact for matter to be freeze dried within the vacuum chamber in which the controller is operative to energize and de-energize at least one of the vacuum pump, heating systems and refrigerant system in response to signals received from the humidity sensor.
